(19) United States
(12) Patent Application Publication
(10) Pub. No.: US 2017/0155510 A1
(43) Pub. Date: Jun. 1, 2017

(54) DEVICE FOR DETERMINING A SHARED KEY

(71) Applicant: KONINKLIJKE PHILIPS N.V., EINDHOVEN (NL)

(72) Inventors: BOUKE CLOOSTERMANS, EINDHOVEN (NL); OSCAR GARCIA MORCHON, AACHEN (DE); RONALD RIETMAN, EINDHOVEN (NL); LUDOVICUS MARINUS GERARDUS MARIA TOLHUIZEN, WAALRE (NL)

(21) Appl. No.: 15/318,238

(22) PCT Filed: Jun. 11, 2015
(86) PCT No.: PCT/EP2015/063024

§ 371 Date: Dec. 12, 2016

(30) Foreign Application Priority Data
Jun. 27, 2014 (EP) 14174755.0

(51) Int. Cl. H04L 9/08; H04L 9/30

(52) U.S. Cl. CPC H04L 9/0891; H04L 9/0861; H04L 9/0838; H04L 9/0894; H04L 9/3093

(57) ABSTRACT

A first device (300) configured to determine a shared key with a second device (350). In cryptography, a key-agreement protocol is a protocol whereby two or more parties that may not yet share a common key can agree on such a key. The first device comprising a private correction function (Λ_{A}( ), and a private univariate key polynomial (372, G_{A}( ). From the private univariate key polynomial a correction function is derived from the correction function a correction factor derived. The intermediate key is modified to reduce the number of possible shared keys.

### FIELD OF THE INVENTION

The invention relates to a device configured to determine a shared key with a further device.

The invention further relates to a system for configuring a device for sharing a key.

The invention further relates to a method to determine a shared key with a further network device, a method for configuring a device for sharing a key, corresponding computer program and computer readable medium.

### BACKGROUND

In cryptography, a key-agreement protocol is a protocol whereby two or more parties that may not yet share a common key can agree on such a key. Preferably, both parties can influence the outcome so that neither party can force the choice of key. An attacker who eavesdrops on all communication between the two parties should learn nothing about the key. Yet, while the attacker who sees the same communication learns nothing or little, the parties themselves can derive a shared key. Key agreement protocols are useful, e.g., to secure communication, e.g., to encrypt and/or authenticate messages between the parties.

A known system for key sharing is disclosed in International Patent Application WO2013174554, included by reference, with title “Key sharing device and system for configuration thereof”, by the same applicant. This system is known as ‘HIMMO’. According to an aspect of the known system, root keying material is generated. The root keying material includes a number of m symmetric bivariate polynomials f₁, f₂, . . . , fₘ of degrees αⱼ. For each participating device a private univariate key polynomial is generated. A trusted third party (TTP) may generate keying material for a device A as follows:

KM^{A}(x)=Σⱼ₌₁^{m}(x,A)>ₚ_{ⱼ}=ΣCᵢ^{A}xⁱ

The notation < . . . >ₚ_{ⱼ} denotes reducing modulo pⱼ each coefficient of the polynomial between the brackets. The numbers p₁, . . . , pₘ are private and part of the root key material.

Once two devices have an identity number A and B and received their respective keying material from the TTP, they may use their keying material to obtain a shared key. Device A may perform the following steps: first, device A obtains the identity number B of device B, then A generates the shared key by computing the following:

K_{AB}=<<KM^{A}(x)|_{x=B}>_{N}>₂b=<<ΣᵢCᵢ^{A}Bⁱ>_{N}>₂b

In this formula N refers to a public global reduction integer, and the key length is referred to as ‘b’.

Adding polynomials over different rings causes the private univariate key polynomial to have a special structure: A's shared key and B's shared key are often, though not necessarily always, equal.

There are various possibilities to reconcile the shared key derived by A and the shared key derived by B, so that they are equal, and usable for cryptographic purposes. Nevertheless, the reconciliation process is considered problematic, so that there is a wish to reduce the amount of reconciliation.

### SUMMARY OF THE INVENTION

The inventors found that once device A substituted the identity number of device B into its private univariate key polynomial, obtaining an intermediate key, the intermediate key defines a set of possible keys that device B may have obtained by substituting the identity number of device A into B's private univariate key polynomial.

The difference between the key A obtained by substituting the identity number of device B and the key B obtained by substituting the identity number of device A is limited. It holds that K_{AB}= [symbol] K_{BA}+δN [symbol] ₂_{^{b}} wherein δ is an integer that is bounded in absolute value: |δ|≦Δ,

This would mean that device B must send at least logₑ (2Δ+1) bits of information about K_{BA} to device A in order for device A to be able to find K_{BA} among the 2Δ+1 candidates defined by K_{AB}. From an information theoretic point of view, this reduces the effective key length from b bits to b−log₂(2Δ+1) bits. Alternatively, device B could send a hash value h(K_{BA}) of K_{BA} to device A. Device A could then find K_{BA} by comparing h(K_{BA}) to the hash values of all candidates of the form [symbol] K_{BA}+δN [symbol] ₂_{^{b}} with |δ|≦Δ. This is time consuming if Δ is large.

It would be advantageous to have an improved device for key agreement.

A first device is provided configured to determine a shared key with a second device, the first device comprising an electronic storage, a communication unit, a polynomial manipulation unit and a key-correction unit.

The electronic storage stores a first identity number, a first private correction function, and a first private univariate key polynomial. The second device has access to a second private univariate key polynomial and a second correction key. Like the first device, it also computes an intermediate key, then a correction factor, and finally a corrected intermediate key. The second device has access to a correction function of its own.

The communication unit is arranged to obtain a second identity number of the second device.

The polynomial manipulation unit is arranged to substitute the second identity number into the private univariate key polynomial, obtaining an intermediate key, the intermediate key defining a first key set, the intermediate key derived by the second device being comprised in the first key set.

The key-correction unit is arranged to substitute the second identity number into the private correction function obtaining a correction factor, and to modify the intermediate key with the correction factor to obtain a corrected key, the corrected key defining a second key set. The second set is smaller than the first set, moreover the corrected key obtained by device B is comprised in the second key set.

The keys in the first key set may be regarded as symmetric keys. The first and second device could derive a shared key from the intermediate key. In this case they would have to reconcile over the size of the first key set.

The private correction function (Λ_{A}( ), reduces the size of the first set, without sending additional reconciliation data. Thus the potential key asymmetry is reduced. Any additional reconciliation data potentially reduces security, thus reducing it is an advantage. Moreover, key reconciliation is less work.

A shared key may be derived from the corrected intermediate key. Deriving a shared key from the corrected intermediate key may comprise receiving reconciliation data and matching the corrected intermediate key to the received reconciliation data, and/or applying a key derivation function. The shared key may combine multiple corrected intermediate keys.

An aspect of the invention concerns a system for configuring a first device for sharing a key. An aspect of the invention concerns a method to determine a shared key with a second device. An aspect of the invention concerns a method for configuring a device for sharing a key.

The first and second devices, and the system for configuring are electronic devices. The first device described herein may be applied in a wide range of practical applications. Such practical applications include communication networks that require secure communications between a large number of potential devices. Such communication networks include lighting networks, and inter car communication.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer

In a preferred embodiment, the computer program comprises computer program code means adapted to perform all the steps of a method according to the invention when the computer program is run on a computer. Preferably, the computer program is embodied on a computer readable medium.

### BRIEF DESCRIPTION OF THE DRAWINGS

These and other aspects of the invention are apparent from and will be elucidated with reference to the embodiments described hereinafter. In the drawings,

FIG. 1 is a schematic block diagram of a system 200 for configuring a network device 300 for key sharing;

FIG. 2 is a schematic block diagram of a first network device 300 and a second network device 350;

FIG. 3a is a schematic block diagram of a key sharing system 100

FIG. 3b is a schematic block diagram of a key sharing system 102

FIG. 4 is schematic block diagram of an integrated circuit 400,

FIG. 5 is a flowchart illustrating a method 500 for configuring a network device for sharing a key,

FIG. 6 is a flowchart illustrating a method 600 for determining a shared key with a second network device 350.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

Below an embodiment of the key sharing method is described first in mathematical terms. The key sharing method may be implemented in devices as described below, e.g., on a system 200 for configuring a network device 300, in a key sharing system 100, 102 and the like. Devices are also referred to as nodes or network nodes.

A plurality of devices according to an embodiment can establish keys between pairs of them with ease, thus allowing secured communication between any two of them. Accordingly, we refer to the devices as network devices. In an embodiment, communication between two devices uses wireless communication. Other forms of communication are also possible, e.g., wired communication, etc.

The method has a set-up phase and a use phase. The set-up phase may include initiation steps and registration steps. The initiation steps do not involve the network devices.

The initiation steps select system parameters. The initiation steps may be performed by the trusted third party (TTP). The system parameters may also be regarded as given inputs. In that case the trusted third party need not generate them, and the initiation steps may be skipped. For example, the trusted third party may receive the system parameters from a device manufacturer. The device manufacturer may have performed the initiation steps to obtain the system parameters. For convenience of exposition we will refer to the trusted third party as performing the initiation steps, bearing in mind that this is not necessary.

### Initiation Steps

The desired key length for the key that will be shared between devices in the use phase of an instance is selected; this key length is referred to as ‘b’. The desired identity number length is also selected. During the later registration steps each device will be associated with an identity number of identity number length; the identity number length is referred to as ‘B’. The length of numbers are measured in bits.

It is preferred that b≦B, but this is not necessary. For higher resistance against lattice attacks, we may choose b<B. In an embodiment B is a multiple of b, say B is at least 2b, or for recommended security levels, B is at least 4b. A typical value for a low security application may be b=8, B=16. For high security b=8, B=32 is better. Higher security could use b≦8 (e.g. b=8), and B≧128 (e.g. B=128).

With each instance the two parties can derive a shared key. The shared keys can be combined to form a larger combined key. The number of instances is chosen so that the combined key is long enough for the security application in which it will be used.

Smaller values of b with respect to B increase resilience to so-called collusion attacks. In a collusion attack, an attacker obtains information on the shared key used between a target network node and multiple colluding network nodes.

Often the number of instances, the key size and the sub-key lengths will be pre-determined, e.g., by a system designer, and provided to the trusted party as inputs.

### Instance Parameters

Next the parameters for each instance are selected. The desired degree is selected; the degree controls the degree of certain polynomials. The degree will be referred to as ‘α’, it is at least 1. A practical choice for a is 2. A more secure application may use a higher value of α, say 3 or 4, or even higher. For a simple application also α=1 is possible. The case α=1 is related to the so called ‘hidden number problem’; higher “α” values are related to the extended hidden number problem confirming that these cases are hard to break. The value α=1, although possible, is not recommended, and should only be considered for very low security applications. For low security application a value of α>2, say α=3 is possible. However, for high security α≧32 is recommended, say α=32.

The number of polynomials is selected. The number of polynomials will be referred to as ‘in’. A practical choice for m is 2. A more secure application may use a higher value of m, say 3 or 4, or even higher.

Note that a low-complexity application, say for resource bounded devices may use m=1. The value m=1, although possible, is not recommended, and should only be considered for low security applications. Higher values of security parameters a and m increase the complexity of the system and accordingly increase its intractability. More complicated systems are harder to analyze and thus more resistant to cryptanalysis. Below it is assumed that m≧2.

A public modulus N is selected satisfying 2^{(α+1)B+b-1}≦N. Preferably, public modulus N is chosen to have exactly (a+1)B+b bits, and thus that also N<2^{(a+1)B+b}. For example, N may be chosen at random in this interval. Often the key length b, degree α and number of polynomials m will be pre-determined, e.g., by a system designer and provided to the trusted party as inputs. The public modulus may also be fixed, say in a standard, but more typically will be selected during generation of the parameters.

A number of m private moduli p₁, p₂, . . . , pₘ are selected. Moduli are positive integers. In an embodiment, each selected number satisfies the following relationship pⱼ=N−βⱼ·2^{b}. Wherein the β^{j} are random B-bits integers, i.e., βⱼ<2^{B}. More preferably the private moduli have a number of bits exactly equal to the identifier-length B, i.e., 2^{B-1}≦βⱼ<2^{B}. The private moduli are referred to as the second private set.

For m>1, the system is more complicated, and thus more secure, since modulo operation for different moduli are combined even though such operations are not compatible in the usual mathematical sense. For this reason it is advantageous to choose the selected private moduli p₁ as pairwise distinct. Outside, very low security application m>1 and α>1 is recommended, through preferably higher values are used.

In an embodiment, m>1, α>1, pⱼ=N−βⱼ·2^{b},βⱼ<2^{B}, and 2^{(α+1)B+b-1}≦N.

A number of m bivariate polynomials f₁, f₂, . . . , fₘ of degrees αⱼ are generated; referred to as the first private set. Preferably, the bivariate polynomials are symmetric; this allows all network devices to agree on a shared key with each other network device. These bivariate polynomials may also be chosen asymmetric. In the latter case, the devices are divided into two groups; a first group obtaining local key material by substituting in a first variable of the bivariate polynomials, a second group obtaining local key material by substituting in the second variable of the bivariate polynomials. Devices in one group can only agree on a shared key with devices in the other group.

All degrees satisfy αⱼ≦α, and for at least one j, we have αⱼ=α. A better choice is to take each polynomial of degree α. A bivariate polynomial is a polynomial in two variables. A symmetric polynomial f satisfies f(x,y)=f(y,x). Each polynomial fⱼ is evaluated in the finite ring formed by the integers modulo pⱼ, obtained by computing modulo pⱼ. The integers modulo pⱼ form a finite ring with pⱼ elements. The coefficients of polynomial fⱼ are integers, and represent an element in the finite ring defined by modulo pⱼ operations. In an embodiment the polynomial f is represented with coefficients from 0 up to pⱼ−1. The bivariate polynomials may be selected at random, e.g., by selecting random coefficients within these bounds.

The security of the key sharing depends on these bivariate polynomials as they are the root keying material of the system; so preferably strong measures are taken to protect them, e.g., control procedures, tamper-resistant devices, and the like. Preferably the selected integers p₁, p₂, . . . pₘ are also kept secret, including the value βⱼ corresponding to pⱼ, though this is less critical. We will refer to the bivariate polynomials also in the following form: for j=1, 2, . . . , m, we write fⱼ(x,y)=Σᵢ₌₀^{α}f_{i,j}(x)yⁱ.

The above embodiment can be varied in a number of ways. The restrictions on the public and private moduli may be chosen in a variety of ways, such that obfuscation of the univariate polynomial is possible, yet that the shared keys obtained at network devices remain sufficiently close to each other sufficiently often. What is sufficient will depend on the application, the required security level and the computing resources available at the network devices. The above embodiment combines positive integers such that the modular operations which are carried out when generating the polynomials shares are combined in a non-linear manner when they are added over the integers, creating a non-linear structure for the local key material stored on a network device. The above choice for N and pⱼ has the property that: (i) the size of N is fixed for all network devices; (ii) the non-linear effect appears in the coefficients forming the key material stored on the device. Because of that specific form the shared small key may be generated by reducing modulo 2^{b} after the reduction modulo N.

### Registration Steps

In the registration step each network device is assigned keying material (KM), including a private univariate key polynomial. The keying material comprises keying material for each instance. Below we describe how keying material for one instance is derived for a network device. Each instance has keying material that is unique to that instance, even though parts of the keying material may be shared among different instances.

A network device is associated with an identity number A. The identity number may be assigned on demand, e.g. by the TTP, or may already be stored in the device, e.g., stored in the device at manufacture, etc. The bit size of A is B bits. Generating A may be done in a variety of ways. For high security the low bits of A are random. For example, A may be selected as a random number; A may be the hash of a further identity number, say a serial number, possibly truncated to B bits.

The TTP generates a set of keying material for a device A as follows:

$${KM}^{A} ( X ) = {\sum }_{j = 1}^{m} < {f}_{j} ( x , A ) {>}_{p , j} = {\sum }_{i} {C}_{i}^{A} {x}^{i} = {G}_{A} ( X )$$

Thus a set of univariate polynomials is obtained, and for each particular polynomial of the first private set, the identity number is substituted (A) into said particular polynomial fᵢ(A,x) and reducing modulo the reduction integer associated with said particular polynomial. The resulting set of univariate polynomials is summed. The summing may be combined with the generating. x is a formal variable. Note that the keying material is non-linear. The notation < . . . >ₚ_{ⱼ} denotes reducing modulo pⱼ each coefficient of the polynomial between the brackets.

It is possible to add further obfuscating numbers to this, as follows: KM^{A}(X)=Σⱼ₌₁^{m}<fⱼ(x,A)>ₚ_{ⱼ}+2^{b} Σᵢ₌₀^{α}ε_{A,i}xⁱ=ΣᵢCᵢ^{A}xⁱ. Wherein KM^{A}(X) is the keying material of a device with identity number A. Stated differently, we have that Cᵢ^{A}=Σⱼ₌₁^{m} [symbol] f_{i,j}(A) [symbol] ₚ_{ⱼ}, +2^{b}ε_{A,i}. The notation ‘ε_{A,i}’ denotes a random integer, which is an example of an obfuscating number, such that |ε_{A,i}|<2^{(α+1-i)b}, Note that any one of the random integers may be positive or negative. The random numbers E are generated again for each device. The term Σᵢ₌₀^{a}ε_{A,i}Xⁱ thus represents a polynomial in X of degree α, of which the coefficient length is shorter with increasing degree. Alternatively, a more general, but more complicated condition is that Σᵢ₌₀^{a}|ε_{A,i}|·2^{b} is small, e.g., <2^{a+1}. The mixing effect over different finite rings provides the largest contribution to security, the use of obfuscating numbers is thus optional.

All other additions may either use the natural integer arithmetic, i.e., in the ring [symbol] , or (preferably) they use addition modulo N. So the evaluation of the univariate polynomials Σⱼ₌₁^{m}<fⱼ(x,A)>ₚ_{ⱼ} is each individually done modulo a smaller modulus pⱼ but the summation of these reduced univariate polynomials themselves is preferably done modulo N. Also adding the obfuscating polynomial 2^{b}Σᵢ₌₀^{a}ε_{A,i}Xⁱ may be done using natural integer arithmetic or, preferably, modulo N. The keying material comprises the coefficients Cᵢ^{A} with i=0, . . . , a. The keying material may be presented as a polynomial as above. In practice, the keying material may be stored as a list, e.g., an array, of the integers Cᵢ^{A}. The device A also receives the numbers N and b. Manipulation of polynomials may be implemented, e.g., as manipulation of arrays containing the coefficients, e.g., listing all coefficients in a predetermined order. Note that polynomials may be implemented, in other data structures, e.g., as an associative array (also known as a ‘map’) comprising a collection of (degree, coefficient) pairs, preferably such that each coefficient appears at most once in the collection. The coefficients Cᵢ^{A} that are provided to the device are preferably in the range 0, 1, . . . , N−1.

Once two devices have an identity number A and B and received their respective keying material from the TTP, they may use their keying material to obtain one small shared key. Device A may perform the following steps, for each instance, to obtain his shared key. First, device A obtains the identity number B of device B, then A generates the shared key by computing the following: K_{AB}=KM^{A}(x)|_{x=B}>_{N}>₂b=<<ΣᵢCᵢ^{A}Bⁱ>_{N}>₂ b

We will refer to this key also as K(A,B). Here A is the B-bit identifier, i.e., 0≦ξ<2^{B}, of device A. [Note that the identifier B of device B is unrelated to the identifier-length which is also referred to as B. For example, the former may be a 128-bit number whereas the former may be the number 128.]

The b-bit key K(A,B) that device A generates, e.g., for encrypting its communication with device B is not always equal to K(B,A), the key that device B generates, e.g., for encrypting its communication with device A. The difference between these keys is limited, however, in the following sense: it holds that K(B,A)= [symbol] K(A,B)+δN [symbol] ₂_{^{b}}, where N is the public global reduction integer, [symbol] [symbol] ₂_{^{b}} denotes the modulo 2^{b} operation and δ is an integer that is bounded in absolute value: |δ|≦Δ. K(A,B) is an example of an intermediate key and it defines a set of possible shared keys by adding or subtracting a multiple of a correction term, i.e. a multiple of N. The multiple is less-or-equal than an upper bound, e.g., Δ, and more-or-equal than a lower bound, e.g., −Δ.

Values for the upper and lower bound may be calculated, and depend on the chosen parameters. Relatively sharp bounds on the difference may be obtained by setting half the bits of the keying material to zero. In this case, we have Δ≦2m+2α+1. Here m denotes the number of mixing polynomials, and α their degree. However, for other embodiments a similar bound may also be obtained by following the derivation of K(A,B) and K(B,A), keeping track of the number of bits that may differ. Without assuming setting coefficients to zero, we have the bound Δ≦2m

A large value Δ is not desirable. A larger value decreases the chance that two devices will arrive at the same shared key by chance, i.e., without further reconciliation. Furthermore, if key reconciliation is started, the work increases with Δ. Also from a cryptographic point of view are large values of A undesirable. For reconciliation, a device B may have to send at least log₂ (2Δ+1) bits of information about K(B,A) to device A, in order for device A to be able to find K(B,A) among the 2Δ+1 candidates. This reduces the effective key length from b bits to b−log₂(2Δ+1) bits. For applications that use small values of b, this is especially undesirable. The first set has a size of 2Δ+1. Reconciliation may instead send a hash value over one or more keys, as reconciliation data.

The TTP is arranged to also compute a private correction function (Λ_{A}( ), that can be used to reduce the size of the first set, without sending additional reconciliation data. Modifying the key agreement so that generated keys always match is considered detrimental to resilience against collusion attacks. However, the correction function allows the bound on the key difference to be greatly reduced while introducing only marginal additional weakness against such attacks, if any.

Preferably, both devices A and B have a correction function. Both derive a correction factor and apply it to an intermediate key. Only one of the two devices may need to engage in reconciliation, say device A, whereas the other device, say device B, may simply use the generated key, say K(B,A) to which device B applied its correction factor. Devices may still participate in the key agreement system without having a correction function. In this case a larger reconciliation is needed. This means the system is backward compatible with devices that do not have a correction function; both devices use a correction function, or both do not use it. The correction factor is generally different for devices A and B.

The private correction function is for each device, its domain is the set of possible identifiers {0,1, . . . ,2^{B}−1} and its range is, e.g., the set {0,1,2, . . . ,2m+2α+1.} This function is calculated by the TTP and is, in a preferred embodiment, a monotonic function, i.e. non-decreasing or non-increasing.

Device A may calculate K(A,B) as before, but this is not going to be its key. K(A,B) is an example of an intermediate key. Instead, device A also calculates (or looks up, as described in the below) Λ_{A}(B) and calculates the key as \tilde{K}(A,B)= [symbol] K(A,B)−NΛ_{A}(B) [symbol] ₂_{^{b}}. Λ_{A}( ) is an example of a private correction function. Λ_{A}(B) is an example of a correction factor. Likewise, Device B calculates \tilde{K}(B,A)= [symbol] K(B,A) NΛ_{B} (A) [symbol] ₂_{^{b}}. Device B also performs a correction, but uses its own correction function, derives its own correction factor, which generally will be different than device A's factor, and applies it to its own intermediate key.

In an embodiment, the modified intermediate keys are almost equal: \tilde{K}(A,B)= [symbol] \tilde{K}(B,A)+δN [symbol] ₂_{^{b}} where δε{−1,0,1}. The second set is thus much smaller than the first set. In this embodiment, we have for the modified intermediate keys the bound Δ=1.

The TTP calculates the function Λ_{A} for each device that participates in the system. Only the TTP can calculate this function, because it depends on the root key material, i.e., secret moduli p₁, p₂, . . . , pₘ and the m polynomials fᵢ(x,y). There are several ways to generate correction functions. Below a number of different options are given:

We assume the m polynomials fᵢ(x,y) are symmetric; note that this is not necessary. Below we represent the m symmetric polynomials fᵢ(x,y) as symmetric matrices of polynomial coefficients R_{j,k}⁽ⁱ⁾. R_{j,k}⁽ⁱ⁾ is the coefficient of x^{j}y^{k} in the bivariate polynomial fᵢ(x,y). Recall that x and y are formal variables.

The key generating polynomial for device A can now be defined as

$${G}_{A} ( X ) = {\sum }_{k = 0}^{α} {〈 {\sum }_{i = 1}^{m} {〈 {\sum }_{j = 0}^{α} {R}_{j , k}^{( i )} {A}^{j} 〉}_{{p}_{i}} 〉}_{N} {X}^{k} .$$

The TTP gives the coefficients of this polynomial to device A, so that device A can calculate K(A,B)= [symbol] G_{A}(B) [symbol] _{N} [symbol] ₂_{^{b}}. To simplify the description we further introduce for each device A the m auxiliary polynomials

$${A}_{A}^{( i )} ( X ) = {\sum }_{j = 0}^{α} {〈 {\sum }_{j = 0}^{α} {R}_{j , k}^{( i )} {A}^{j} 〉}_{{p}_{i}} {X}^{k} = {〈 {f}_{i} ( A , X ) 〉}_{{p}_{i}} .$$

In terms of these polynomials, define the function

$${Λ}_{A}^{′} ( X ) = {\sum }_{i = 1}^{m} \frac{N - {p}_{i}}{N {p}_{i}} {A}_{A}^{( i )} ( X ) .$$

Note that the function Λ′_{A} is a polynomial of degree α with rational coefficients. The variable X is formal, but may during operation be replaced by a device identifier.

A correction function can be obtained by providing an integer approximation for the function Λ′_{A}(X) at least for valid identifier values, e.g., over the range {0, . . . , 2^{B}−1}. Such an approximation is an integer-valued monotonic step-function. In an embodiment, the correction function is non-polynomial. In this context non-polynomial means that the Lagrange interpolation polynomial L(X) that has the same values as the correction function, i.e., Λ_{A}(X)=L(x), for all x in the range {0, . . . , 2^{B}−1}, has a degree larger than a, and in fact typically far larger, say degree of L(x) is 10α or higher.

For example a correction function Λ_{A}(X) may be given by

$${Λ}_{A} ( X ) = ⌊ {\sum }_{i = 1}^{m} \frac{N - {p}_{i}}{N {p}_{i}} {A}_{A}^{( i )} ( X ) ⌋ ,$$

wherein └ ┘ indicates rounding downwards to the nearest integer, so └x┘=max{nεZ|n≦x}.

The summation is over the rational numbers. Rational number may be represented digitally as pairs of integers indicating numerator and denominator. This correction function, like the other correction functions, is an integer-valued function. Note that this function is non-polynomial. It is generally not the case that a rational-polynomial with non-integer coefficients rounded down is itself a polynomial; also Λ′_{A}(X) takes on non-integer values.

Note that the function being rounded is a polynomial in X with non-negative coefficients, so that Λ′_{A}(X) is a non-decreasing function on its domain {0,1, . . . ,2^{B}−1}. The function may be replaced by its negative, in which case it is non-increasing. The latter has the consequence that correction terms are added instead of subtracted. In both cases the private correction function Λ_{A}(X) is monotonic.

Λ_{A}(X) may be stored by storing its coefficients. Alternatively, the monotonicity implies that is the private correction function Λ_{A}(X) may be uniquely characterized by (up to) 2m+2α+1 integer breakpoints I_{A,1}, I_{A,2}, . . . where I_{A,k}=min{x|Λ(x)=k}. This means that Λ_{A}(B)=k if I_{A,k}≦B<I_{A,k+1} where 1≦k≦2m+2α; Λ_{A}(B)=0 if 0≦B<I_{A,1} and Λ_{A}(B)=2m+2α+1 if I_{A,2m+2α+1}≦B. The number of breakpoints may be increased or decreased in dependency on the bound Δ on the difference between intermediate keys.

Storing breakpoints instead of coefficient of the correction function saves storage space since the coefficients of the correction function are rational, and have a large nominator and denominator.

The TTP can find the values I_{A,k}, by means of a search algorithm, e.g., bisection, and gives these values to device A. Device A can now evaluate Λ_{A}(B) by comparing B with the values I_{A,k}, as described above.

Several variants are possible to approximating Λ′_{A} are possible. For instance, one may use rounding to the nearest integer in the definition of Λ_{A}(X) (in that case the range becomes {0,1, . . . ,2m+2α+2}). This could be generalized further than a form of rounding. Specifying Λ_{A}(X) within any range of size 1 will yield the same result. The latter may be obtained by rounding to the nearest integer instead of rounding down, or rounding to smallest larger integer. Specifying Λ_{A}(X) within any range of integer size k will let Δ=k. For example, Λ_{A}(X) may be obtained by rounding to the nearest even integer (k=2), or the nearest multiple of a predetermined integer. These measures reduce the storage size required to store breakpoints.

The TTP may also give incomplete information to the devices, so that device A cannot calculate Λ_{A}(X) exactly, but only approximate it. This leads to a somewhat larger maximum asymmetry Δ in the modified keys, but this may still be acceptable.

There are different ways to approximate Λ′_{A}. For example, the rational polynomial may be approximated by one or more, highest order terms. The high-order approximation can be evaluated by a device and then rounded, e.g. rounded down.

For example, the private correction function (Λ_{A}( )), may be a rounded polynomial with rational coefficients. In an embodiment, the private correction function is a rounded polynomial with a single term having a rational coefficient, e.g., Λ_{A}(y)=└Ry^{α}┘, wherein R is a non-integer rational number. For example, in an embodiment Λ_{A}(y)=

$$⌊ \frac{1}{N} ⌊ {2}^{- r} {a}_{α} ⌋ {2}^{r} {y}^{α} ⌋ .$$

To store this function only the number └2^{-r}a_{α}┘ needs to be stored, and possibly the number r. In this formula, a_{α} is the coefficient of y^{α} in Λ′_{A}(y). The number r is indicative of the number of bits with which we approximate this coefficient. If the identifier bit-length equals the intermediate key length (B=b), then a good choice for r is 2b−2.

All of the described correction functions greatly reduce key-inequality. In fact one may derive the following theorem: Let Γ_{ξ}(y) be any real-valued function such that

$${Λ}_{ξ} ( η ) - 1 ≦ {Γ}_{ξ} ( η ) ≦ {Λ}_{ξ} ( η ) for all 0 < η < {2}^{b} . Let {K}_{ξ , η}^{′} = {〈 {K}_{ξ , η} - ⌊ {Γ}_{ξ} ( η ) + \frac{1}{N} {〈 {G}_{ξ} ( η ) 〉}_{N} ⌋ N 〉}_{{2}^{b}} .$$

Then there exists a δ′_{ξ,η}ε{−1,0,1} such that K′_{ξ,η}= [symbol] K′_{η,ξ}+δ′_{ξ,η}N [symbol] ₂_{^{b}}. Herein, \tilde{K} and K′ denote the same function. [symbol] Correction functions can also be applied when having multiple instances, in which case a device stores more than one key generating polynomial and evaluates each of these polynomials modulo a different parameter analogous to N. In that case, each key generating polynomial is accompanied by its own correction function.

### Use Phase

Once two devices have an identity number A and B and received their respective keying material e from the TTP, including a private univariate key polynomial and a private correction function, they may use their keying material to obtain a shared key.

Device A may perform the following steps, for each instance, to obtain his shared key.

First the devices compute an intermediate key: device A obtains the identity number B of device B, then A generates the intermediate key by computing the following:

K_{AB}=<<KM^{A}(x)|_{x=B}>_{N}>₂_{^{b}}=<<ΣᵢCᵢ^{A}Bⁱ>_{N}>₂_{^{b}}

That is, A evaluates his keying material, seen as an integer polynomial, for the value B; the result of evaluating the keying material is an integer. Next device A may reduce the result of the evaluation first modulo the public modulus N and then modulo the key modulus 2^{b}. The result will be referred to as A's intermediate key, it is an integer in the range of 0 up to 2^{b}−1. For its part, device B can generate B's intermediate key with A by evaluating its keyed material for identity A and reducing the result modulo N and then modulo 2^{b}. Note that K_{AB} is another notation for K(A,B).

If the bivariate polynomials in the root key material are symmetric A's intermediate key and B's intermediate key with A are often, though not necessarily always, equal. The particular requirements on the integers p₁,p₂, . . . , pₘ, and on the (optional) random numbers ε are such that the keys are often equal and almost always close to each other modulo two to the power the key length.

Even if A and B have not obtained the same shared key, it is certain that these keys are close to each other, in the sense that K_{AB}=K_{BA}+δN mod 2^{b}; herein δ is a small number, at most 2m+2α+1 in absolute value; the value may be further reduce by imposing restrictions on the coefficients, as indicated above. Thus the intermediate key gives information on the intermediate key derived by the other party, but nevertheless still allows a comparatively first set of possible shared keys. A first key set of possible keys may be defined by the intermediate key K_{AB} and adding or subtracting a multiple of a correction term (N), and reducing modulo 2^{b}, the multiple (δ) being less than an upper bound and more than a lower bound, e.g. ±(2m+2α+1).

In an example the size of the first key set is less than 1000 keys, more preferably less than 100, more preferably less than 10. The size of the first key set increases, e.g., with the number of polynomials m; the latter may be used to control the size of the first key set.

Devices A and B also derive a correction factor by substituting the identity number of the other party into their private correction function. The intermediate key is modified with the correction factor to obtain a corrected key. In an embodiment, the modified intermediate key is calculated as \tilde{K}(A,B)= [symbol] K(A,B)−NΛ_{A}(B) [symbol] ₂_{^{b}}. In other words modifying the intermediate key comprises multiplying the correction factor Λ_{A}(B) with the public global reduction integer N and adding or subtracting the result of the multiplication to the intermediate key.

It can be shown that this procedure reduces the possible key asymmetry: \tilde{K}(A,B)= [symbol] K(B,A)+δN [symbol] ₂_{^{b}} where δε{−1,0,1}. In other words the modified intermediate key gives information on the modified intermediate key derived by the other party, this still allows a second set of possible corrected intermediate keys; however the second set is much smaller than the first set.

The second key set may be defined by the modified intermediate key \tilde{K}_{AB} and adding or subtracting a multiple of a correction term (N), and reducing modulo 2^{b}, the multiple (δ) being less than an upper bound and more than a lower bound, e.g. ±1.

The correction function may be evaluated in a manner corresponding to its representation. For example, if the correction function is stored as a sequence of integer breakpoints, I_{A,1}, I_{A,2} . . . such that Λ_{A}(x)=0 if x≦I_{A,1}, and such that Λ_{A}(x)=i if I_{A,i}<x≦I_{A,i+1}. Then Λ_{A}(B)=k if I_{A,k}≦B<I_{A,k+1}. Here, k is bounded by the size of the first set, e.g., 1≦k≦2m+2α; Λ_{A}(B)=0 if 0≦B<I_{A,1} and Λ_{A}(B)=2m+2α+1 if I_{A,2m+2α+1}≦B. Preferably, the breakpoints are stored in a sorted order. If the correction function has been rounded further, reducing the number of breakpoints, the correction factor in correspondingly increased.

If the private correction function (Λ_{A}( )), is a rounded polynomial with rational coefficients, then the rounded polynomial may be evaluated for the identity number of the other party and rounded, e.g., rounded down/up or to the nearest integer.

At this point it is very likely that the modified intermediate keys of party A and B are equal. If A and B have obtained the same key, then they may use it as a symmetric key which is shared between A and B; for example, it may be used for a variety of cryptographic applications, for example, they may exchange one or more messages encrypted and/or or authenticated using the shared key. Preferably, a key derivation algorithm is applied to the shared key for further protection of the master key, e.g., a hash function may be applied.

Parties A and B may verify that they have indeed obtained the same key after modification by sending key reconciliation data. For example, by sending a hash of the modified key, or sending an encryption of a predetermined string, etc. If the key reconciliation data shows that the same shared key has not been obtained then, the corrected key may be modified to conform to the received key reconciliation data, so that the first device and second device obtain access to an identical shared key. The modifying may involve trying different values of S, e.g., the values 1, and −1.

The selected m private moduli, p₁, p₂ . . . Pₘ, are preferably pair wise relatively prime. If these numbers are pair wise relatively prime the lack of compatibility between the modulo operations is increased. Obtaining pair wise relatively prime numbers may be obtained by selecting the integers in order, testing for each new integer if all pairs of different numbers are still relatively prime, if not the just selected number is removed from the set. This procedure continues until all m numbers are selected. The complexity increases even further by requiring that the selected m private moduli, p₁, p₂, . . . pₘ are distinct prime numbers.

### Combining Multiple Instances

The system described allows network nodes to agree on shared keys that may be small, also smaller than their identifiers. The combination of higher security and practical implementation makes it desirable to choose values of b that are relatively small, say b≦8 or possibly even b≦16. Such choices of b are however too small for secure encrypted communication. This could be resolved by choosing a much larger value of B, for example, by selecting the identity number length B as 512 bits or more, and the key length b as 128 bit or more. In this case, a single instance would allow two network nodes to share a key of b bits, which is sufficiently long for secure communication. However, having B=512 makes the local key material correspondingly larger. It is thus possible, even using only moderately powerful network devices, say mobile phones, to configure the network device for securely sharing a key that is sufficiently long for secure communication, yet requiring only a single instance. Nevertheless it would be very desirable to reduce storage requirements while still deriving sufficiently long shared keys.

One way to increase key length without creating impractically long key material is to combine multiple small keys. The system allows the party to agree on multiple sub-keys which together form the shared key. We will refer to the system that generates a sub-key as a key-agreement instance. Each instance may have its own independent parameters, but operates along the same principles as the other instances. Nevertheless, the multiple instances may share some of their parameters. We will refer to a shared key obtained from a system as described above, i.e., from a single instance, as a ‘small’ key, and the combination of two or more small keys as a ‘large keys’. The number of instances combined is referred to as ‘t’.

A first way to obtain multiple small keys is to select multiple fully independent instances. However, since security requirements for each of the small keys are equal, the multiple instance will typically have the same values for b, B, α, and m. The TTP generates a public modulus N, private moduli pᵢ, private polynomials fᵢ for each instance, and for each instance and each network node an identifier A and local key material KM^{A}.

A second way to combine multiple instances is to use for each instance the same identifier A. A third way is to use for each instance the same public modulus N. Finally, one could use the same identifier A and the same public modulus N. The local key material will not be the same for all instances.

Each instance also has its own correction function. Interestingly, the reconciliation data may be computed of more than one small key. This reduces the information that may be leaked in the reconciliation data. A result if that multiple small keys need to be reconciled at the same time. However, as the size of the second set has been reduced this is less work.

For example, the size of the shared large key depends on the security requirements, it may be 64 or 80. A typical value for a consumer level security may be 128. Highly secret applications may prefer 256 or even higher values. In an embodiment the length of the combined key is equal to the length of the identifier B.

Also the number of instances ‘t’ and the sizes of the sub-keys are selected. The sizes of the sub keys in different instances may be different. We may refer to the size of a sub key in instance ‘i’ as ‘bᵢ’. These are chosen so that Σbᵢ≧B. For simplicity we will drop the index, and denote the size of the sub-key below as ‘b’. Typically, the size of the sub-keys will be equal in all instances, and chosen such that bt=B.

Each device uses the different instances of key material to generate sub-keys. The shared key is then generated from the sub-keys, e.g., by concatenating the sub-keys.

Amongst others, the following parameter set for B=32 has been experimentally verified to be more secure than others: alpha=10, b=8, B=32, this system requires 4 instances to make a 32 bit key. The parameter set alpha=3, b=8, B=32 is also secure, however with this lower choice of alpha, it is advisable to use the full span of 32 bits IDs. In particular, in any interval of length 256, less than 10 IDs should be used. In general, more security is achieved by setting pre-determined first and second identity threshold and choosing identity numbers such that no interval of size of the first identity threshold (e.g. 256) contains more than the second identity threshold (e.g. 10) of identity values. This can be enforced for example, by the network device manager, e.g., by generating identity values according to this rule, or by refusing generation of local key material for devices having a identify value that exceeds the thresholds.

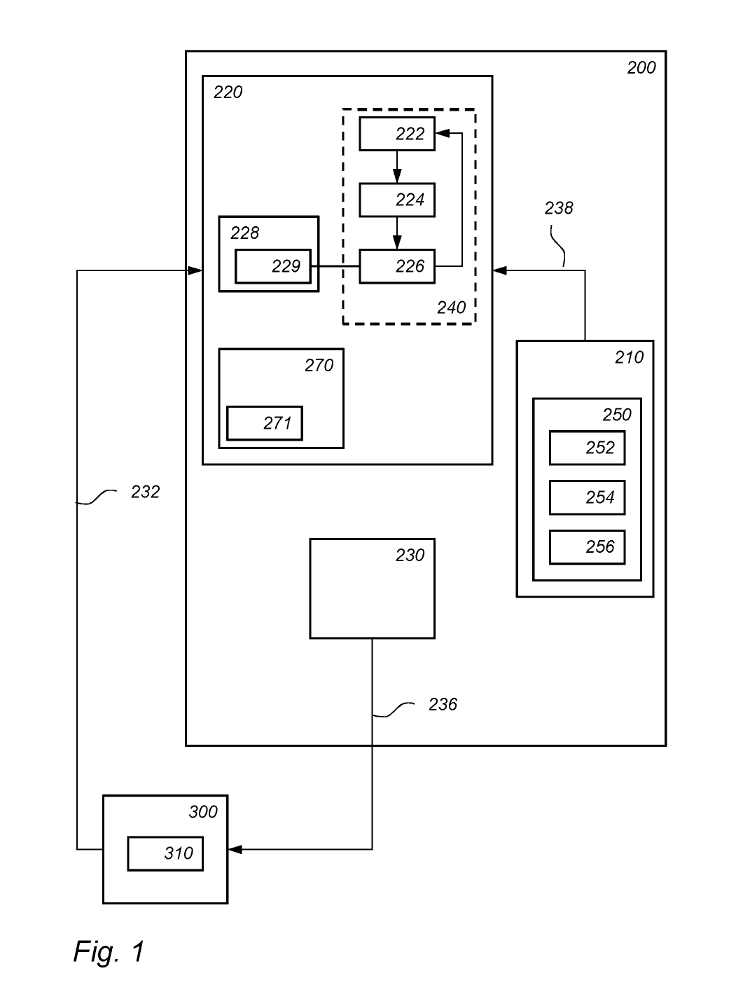

FIG. 1 is a schematic block diagram of a system 200 for configuring a network device for key sharing and a first device 300. We refer to device 300 as a network device.

System for configuring 200 is typically implemented as an integrated device. For example, system for configuring 200 may be comprised in a server. System for configuring 200 may configure network devices over a network, say a wireless network, or the internet, and the like. However, system for configuring 200 may also be integrated in a manufacturing device for manufacturing the network devices.

System for configuring 200 comprises a key material obtainer 210, a network device manager 230 and a computation unit 220. System for configuring 200 is intended to work with multiple network devices. FIG. 1 shows one such device, first network device 300.

System for configuring 200 selects secret key material, also referred to as root key material. System for configuring 200 then derives local key material for each of the multiple network devices. The local key material is derived from the root key material and at least one public identity number A of the network device. In FIG. 1, network device 300 stores identity number 310. A network device may also have multiple identity numbers, e.g., one per instance. Network device may also store a further identity number and derive the identity number 310 therefrom when needed, e.g., by hashing the further identity number.

The local key material comprises parts that are private to a particular network device, i.e., only accessible to one particular network device and possibly trusted devices. The local key material may also contain parts that, though needed to obtain a shared key, are less critical to keep secret.

The use of the adjectives public and private, is intended as helpful for understanding: Even with access to all public data, the private data cannot be computed, at least not without unreasonable high resources given the security of the application or compared to the resources needed for key generation, encryption and decryption. However, ‘public’ does not mean that the corresponding data is necessarily made available to anybody else than system for configuring 200 and the network devices. In particular, keeping the public global reduction integer and other public parameters secret from untrusted parties increases security. Likewise, access to private data may be restricted to the party that generated or needs that data, this increases security. However, a trusted party may be allowed access to the private data; Access to private data reduces security.

Using their local key material and the identity number of the other party, the network devices can agree on a shared key between them.

Key material obtainer 210 is configured to obtain in electronic form at least a parameter set 250. The parameter set 250 comprises a public global reduction integer 256, N, a first private set of bivariate polynomials 252, fᵢ(,), and a second private set of reduction integers 254, pᵢ, with each bivariate polynomial in the first set there is associated a reduction integer of the second set, and a public global reduction integer 256, N. The parameter set is generated for network nodes having identifying number of bit-size B. The parameter set will be used for generating local key material which in turn will be used to derive a shared key. In an embodiment, the bit-size of the small key b satisfies b<B; Although this is not necessary, it makes the corresponding lattice problem harder. In an embodiment, b≦B, particular, b may equal B.

In preferred embodiments, the key material obtainer 210 is configured to obtain in electronic form a parameter set 250. If multiple instances are used, key material obtainer 210 may comprises multiple parameter sets. FIG. 1 shows a parameter set 250.

The public global reduction integer of a parameter set 256, N is different from each of the reduction integers 254 of that set. Preferably, the public global reduction integer of a parameter set 256, N is larger than each of the reduction integers 254 of that parameter set.

Key material obtainer 210 does not need interaction with a network device for obtaining the key material; in particular key material obtainer 210 does not need an identity number. System for configuring 200 may be a distributed system in which key material obtainer 210 is located at a different physical location than computation unit 220. Key material obtainer 210 generates all or part of the key material and/or obtains all or part of the key material from an external source. For example, key material obtainer 210 is suited to receive the public global reduction integers 256 from an external source and generate the first private sets 252 and second sets 254. The latter allows all network devices to be manufactured with a fixed public global reduction integers 256 reducing cost.

Key material obtainer 210 may comprise an electronic random number generator. The random number generator may be a true or pseudo random number generator. Key material obtainer 210 may generate a public global reduction integer, N, e.g., using the electronic random number generator. Although, the public global reduction integer is public information, introducing randomness makes analyzing the system more difficult.

With each bivariate polynomial in a first set, a reduction integer from a second set is associated. The random coefficients may be randomly selected from an integer ring, e.g., the integers modulo a number, such as the associated reduction integer.

Key material obtainer 210 may generate one or more coefficients of a reduction integer pᵢ in a second private set using the electronic random number generator. It is not necessary that the reduction integers are primes. However, they may be chosen as prime to increase resistance. Prime numbers give rise to fields, which is a species of rings. The same parameter sets, i.e., the same first and second private sets, and public global reduction numbers, are used for all network devices that later need to share a key.

Key material obtainer 210 may generate one or more coefficients of a bivariate polynomial fᵢ(,)) in a first private set 252, e.g., using the electronic random number generator. Key material obtainer 210 may generate all of the bivariate polynomial in this fashion. Key material obtainer 210 may use a maximum degree of these polynomials, say 2, or 3 or higher, and generate one more random coefficient than the degree.

It is convenient to prescribe some aspects of first private sets 252 such as the number of polynomials in private sets 252 and the degrees of the polynomials, or the maximum degrees. It may also be prescribed that some of coefficients in the polynomials are zero, e.g., for reducing storage requirements.

A first set may contain two equal polynomials. This will work, however, unless the associated reduction integers are different the sets may be reduced in size. So typically, whenever two or more bivariate polynomials in the first set are the same, the associated reduction integers, i.e. the underlying ring, is different.

In an embodiment all first private sets of bivariate polynomials (fᵢ(,)) only comprises symmetric bivariate polynomials. Using only symmetric polynomials has the advantage that each network device can agree on a shared key with any other network device of the configured network devices. However, a first private set of bivariate polynomials may contain one or more asymmetric polynomials; this has the effect that the devices can be portioned into two groups: a device from one group can only agree on a shared key with a device of the second group.

Key material obtainer 210 is configured to obtain in electronic form a first private set of bivariate polynomials 252, also referred to as fᵢ(,) in formulas. The embodiment described below assumes that all bivariate polynomials in set 252 are symmetric. Generation of the second parameter set may be done in the same manner.

A symmetric bivariate polynomial may also be notated as fᵢ(x,y) with two formal variables as placeholder. A symmetric bivariate polynomial satisfies fᵢ(x,y)=fᵢ(y,x). This requirement translates to a requirement on the coefficients, e.g., that the coefficient of a monomial x^{a}y^{b} equals the coefficient of a monomial x^{b}y^{a}.

The number of polynomials in first private set 252 may be chosen differently depending on the application. The system will work when the first and second set contain only a single polynomial; in such a system keys may be successfully shared and provide a moderate level of security. However, the security advantage of mixing over different rings is only achieved when the first set has at least 2 polynomials in them, and the second set has at least two different reduction integers.

Private set 252 comprises at least one bivariate polynomial. In an embodiment of initiating key-agreement device 100 the private set 252 consists of one polynomial. Having only one polynomial in private set 252 reduces complexity, storage requirements and increases speed. However, having only one polynomial in private set 252 is considered less secure than having two or more polynomials in private set 252 because such a one-polynomial system does not profit from additional mixing in the summation described below. However, key sharing will work correctly and are considered sufficiently secure for low-value and/or low-security applications.

In the remainder, we will assume that private set 252 comprises at least two symmetric bivariate polynomials. In an embodiment, at least two, or even all of the polynomials are different; this complicates analysis of the system considerably. It is not necessary though, private set 252 may comprise two equal polynomials and still benefit from mixing in the summation step if these two polynomials are evaluated over different rings. Note that different reduction integers define different rings. In an embodiment, private set 252 comprises at least two equal polynomials associated with different associated reduction integers. Having two or more equal polynomials in the first set reduces storage requirements. In an embodiment, the second set comprises at least two polynomials, and all polynomials in the second set are different.

The polynomials in private set 252 may be of different degrees. With the degree of a symmetric bivariate polynomial we will mean the degree of the polynomial in one of the two variables. For example, the degree of x²y²+2xy+1 equals 2 because the degree in x is 2. The polynomials may be chosen to have the same degree in each variable; if the polynomials in private set 252 are symmetric the degree will be the same in the other variable.

The degrees of polynomials in private set 252 may be chosen differently depending on the application. Private set 252 comprises at least one symmetric bivariate polynomial of degree 1 or higher. In an embodiment, private set 252 comprises only polynomials of degree 1. Having only linear polynomials in private set 252 reduces complexity, storage requirements and increases speed. However, having only degree one polynomials in private set 252 is considered less secure than having at least one polynomial of degree at least two in private set 252 because such a system is considerably more linear. Even so, if multiple polynomials in private set 252 are evaluated over different rings, then the resulting encryption is not linear even if all polynomials in private set 252 are. In an embodiment, private set 252 comprises at least one, preferably two, polynomials of degree 2 or higher. However, key generation, encryption and decryption will work correctly if only degree 1 polynomials are used, and are considered sufficiently secure for low-value and/or low-security applications.

Having one or more polynomials in private set 252 with degree 0 will not impact the system, so long as the polynomial(s) with higher degree provide sufficient security.

For a mid-security application, private set 252 may comprise, or even consist of, two symmetric bivariate polynomials of degree 2. For a higher security application, private set 252 may comprise or even consist of two symmetric bivariate polynomials, one of degree 2 and one of degree higher than 2, say 3. Increasing the number of polynomials and/or their degrees will further increase security at the cost of increased resource consumption.

Preferably, the reduction integers are selected so that the difference of any two reduction integers in the same set of reduction integers has a common divisor. In particular, common divisor may be 2^{b}; or in words, the difference between any two reduction integers end in a least as many zero's as the size of the small key that will be derived from this instance.

For example, one way to generate the reduction integers and the public global reduction integer is as follows.

1. First generate the public global reduction integer N. For example as a random integer of prescribed size,

2. For each reduction integer, generate an integer βᵢ and generate the reduction integer pᵢ as the difference pᵢ=N−βᵢ2^{b}

The public global reduction integer may be chosen to have (α+1)B+b bits or more, wherein α is the highest degree in a single variable of the bivariate polynomials in the first private set. In that case, the integers βᵢ may be chosen as βᵢ<2^{B}.

Key material obtainer 210 may be programmed in software or in hardware or in a combination thereof. Key material obtainer 210 may share resources with computation unit 220 for polynomial manipulation.

Network device manager 230 is configured to obtain in electronic form an identity number 310, A for network device 300. Network device manager 230 may receive the identity number from the network device. For example, network device manager 230 may comprise or make use of a communication unit for receiving the identity number over a network. For example, network device manager 230 may comprise an antenna for receiving the identity number as a wireless signal. The identity number may be represented as a number of bits, typically, the number of bits in the identity number b is at least as large as the number of bits in the shared key.

System 200 may use the same identity number for all parameter sets. However, it is also possible to use a different identity numbers for different parameters sets. In the latter case, network manager 230 obtains multiple identity numbers.

Computation unit 220 is configured to compute a univariate private key polynomial 229 for a parameter set and an identifying number A. Computation unit 220 is applied to each of the parameter sets of key material obtainer 210. In an embodiment, the computation unit uses the same identifying number for at least two, or even for each of the parameter sets. In an embodiment, the polynomial manipulation unit uses a different identifying number of a network device for at least two, or even for all of the parameter sets. The univariate private key polynomials that are thus obtained and the corresponding public global reduction integers are part of the local key material that will be sent to the network device.

Computation unit 220 receives the data in a parameter set from key material obtainer 210 over connection 238. Below it is described how computation unit 220 determines a univariate private key polynomial from the parameter set. The generation of a univariate private key polynomial from the other parameter set is done in the same manner.

Computation unit 220 may compute the univariate private key polynomial 229 as follows:

Univariate polynomials are obtained by substituting the identity integer A into each of the polynomials in the first private set of the parameter set that is currently processed. By substituting a value for only one variable of a bivariate polynomial, the bivariate polynomial reduces to a univariate polynomial. The resulting univariate polynomial is then reduced modulo the reduction integer associated with the bivariate polynomial in which the identity integer A was substituted. The resulting set of univariate polynomials is summed, e.g., by adding the coefficients of equal powers of y in the polynomials. This may be obtained from the formula for Cᵢ^{A} in: KM^{A}(X)=Σⱼ₌₁^{m}<fⱼ(x,A)>ₚ_{ⱼ}=Σᵢ Cᵢ^{A}xⁱ

Suppose fᵢ(x,y) is one of the bivariate polynomials in the first private set. The coefficients of this polynomial are taken from the ring [symbol] ₚ_{ᵢ}. That is the coefficients of the polynomials in the first set are taken from an integer ring. For simplicity, the variables x and y are used to represent the formal variables of the integers in the first set.

After substitution, computation unit 220 obtains fᵢ(A,y). Computation unit 220 is further configured to reduce this term modulo pᵢ. Coefficients are reduced in the ring over which the system operates, e.g., Zₚ, e.g., by reducing mod p. Preferably, computation unit 220 brings the result into a canonical form, i.e., a predetermined standardized representation. A suitable canonical form is representation of the coefficient sorted by degrees of the monomials. Alternatively, the substitution may be for y.

To ensure that the identity numbers act ‘random’ in the system a randomization step at point in the chain is advisable to ensure that lattice attacks do not simplify. Especially if the network devices are given identity numbers according to a particular order, e.g., serial numbers, such a randomization step is advisable. For example, a cryptographic hash, say, sha-256 may be applied to the identity number, the result being shortened to B bits.

Furthermore, identity numbers may be extended to more bits. For example, an identity number of B′ bits may extended, e.g., by hashing and/or concatenation, to B bits, with B′<B. For example and identity number A may be extended to H(A) or to A∥H(A); H denotes hashing and II denotes concatenation. The concatenation is done at the LSB side. A highly non-linear hash, such as a cryptographic hash is preferred for this operation.

If the first set only contains symmetric polynomials, then substitution of the identity integer A may be in either one of the two variables of the bivariate polynomial. However, if substitution is done in an asymmetric polynomial, more care is needed. For example computation unit 220 may be configured to obtain whether first network device 300 is in a first or second group. The first and second groups are associated with the first and second variable of the bivariate polynomials, respectively. For a network device in the first group always the first variable is used. For a network device in the second group always the second variable is used.

FIG. 1 shows one possible way to implement this function. FIG. 1 shows a substituting unit 222, a polynomial reduction unit 224, a polynomial addition unit 226 and a sum of a set of univariate polynomials 228; the latter will be univariate private key polynomial 229.

Substituting unit 222, a polynomial reduction unit 224, and a polynomial addition unit 226 may be organized into a polynomial manipulation unit; this option has been indicated by dashed lines in FIG. 1.

These may work as follows. Substituting unit 222 substitutes the identity integer A into a bivariate polynomial of the first set. Substituting unit 222 may collect terms to bring the result in canonical form, but this may also wait. Polynomial reduction unit 224 receives the result of the substitution and reduces it modulo the reduction integer associated with the bivariate polynomial in which was substituted.

The result of substituting the identity integer A into said particular polynomial fᵢ(A,y) and reducing modulo the reduction integer associated with said particular polynomial is represented as a list of coefficients in a canonical form before the summing by polynomial addition unit 226. The variable y acts as a formal variable. This substitution is sometime notated simply as: fᵢ(A,).

Polynomial addition unit 226 receives the reduced univariate polynomials and adds them to a running total in sum 228. Sum 228 was reset to 0 prior to the generation of the univariate private key polynomial. Polynomial addition unit 226 may add the polynomials coefficient-wise, using either natural arithmetic or modulo the public global reduction number associated to the parameter set.

When all polynomials of the first private set are processed in this way, the result in sum 228 may be used as the univariate private key polynomial. The resulting univariate private key polynomial, say in sum 228, may be represented as a list of coefficients and in a canonical form.

If system 200 uses multiple instances, i.e., if system 200 uses multiple parameter sets, then computation unit 220 determines a univariate private key polynomial for each of them. If needed unit 220 may re-use some information, e.g., unit 220 may use the same identity number A to generate all univariate private key polynomials. For more security the parameter sets are independent, and preferably also use a different identity number.

Computation unit 220 also comprises a correction function unit 270 arranged to calculate a correction function 271 corresponding both to identity number 310 and parameter set 250. For example, unit 270 may be arranged to calculate

$${Λ}_{A} ( X ) = ⌊ {\sum }_{i = 1}^{m} \frac{N - {p}_{i}}{N {p}_{i}} {A}_{A}^{( i )} ( X ) ⌋$$

wherein A_{A}⁽ⁱ⁾(X)= [symbol] fᵢ(A,X) [symbol] ₚ_{ᵢ}

Breakpoints may be calculated by repeated intersection in the interval 0−2^{B}. Breakpoints reduce the amount of storage space. Moreover, they also reduce the amount of information that stored in the network devices. The individual coefficients of the correction function do not need to be stored. These rational coefficients are determined from root key material, using breakpoints a device can still evaluate the correction function, but beyond this he had no additional information. This improves security.

Alternatively, one (preferably) or more coefficients of the highest order terms of Λ′_{A}, may be computed. This may be done by selecting the highest order terms of the univariate polynomials fᵢ(A,X), evaluated over the integers, and added over the integers. This single number may be distributed together with the local key material of device A. Network device manager 230 is further configured for electronically storing the generated univariate private key polynomial 229, the corresponding public global reduction integers 256, N, and the correction function 271 at the network device. Using the univariate private key polynomials 229 and its identity number or numbers, first network device 300 can share keys with other devices configured from the same root material. Network device manager 230 may also be configured for electronically storing the parameters B and b at the network device.

Electronically storing may comprise that the device manager electronically sends the information to the first device, the first device then stores the information.

Although computation unit 220 may be implemented in software, computation unit 220 is particularly suited for implementation in hardware. If only polynomial reduction unit 224 is implementing hardware a significant speed improvement will be obtained; part of the functionality of system 200 that is not performed by a hardware version of the unit 224 may be performed in software running of a processor.

FIG. 1 shows computation unit 220 receiving an identity number message 232 from first network device 300; first network device 300 receiving a private key material message 236 from computation unit 220. Private key material message 236 may include a public global reduction integer, a univariate private key polynomial and a correction function.

These messages typically are sent and received through network device manager 230. Private key material message 236 may be split over multiple messages. If multiple instances are used they may combine their corresponding private key material message into a single message.

System for configuring 200 may be configured to obtain an identity number by generating an identity number for first network device 300. Such a configuration is well suited to a manufacturing facility. In that case first network device 300 receives identity number message 232 from configuration system 200, instead of sending it, say receive identity number message 232 from key material obtainer 210 or computation unit 220.

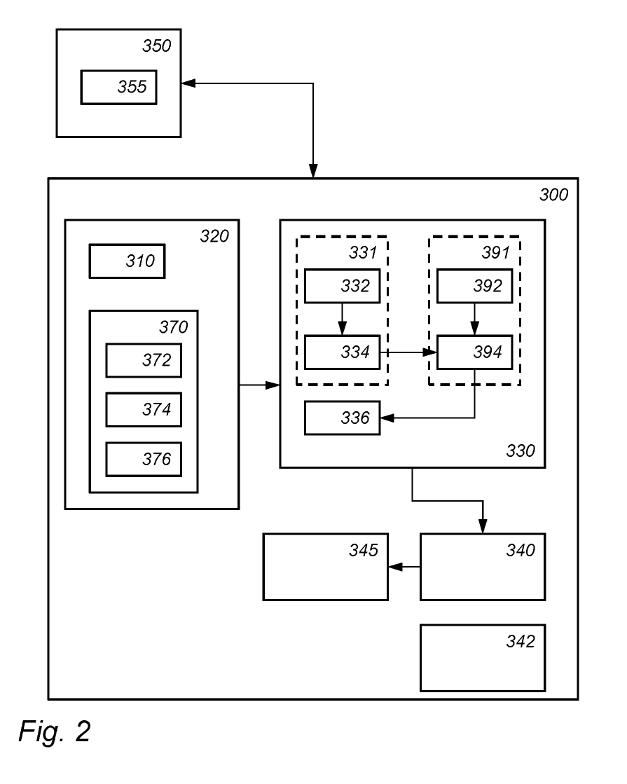

FIG. 2 is a schematic block diagram of a first network device 300 and a second network device 350. First network device 300 and second network device 350 are configured to determine a shared key together.

Second network device 350 may be of the same design as network device 300. We only describe first network device 300 in detail, second network device 350 may be the same or similar. FIG. 2 only shows that second network device 350 stores an identity number 355. The identity number 355 of second network device 350 is public and may be exchanged with network device 300 to share a key. Second network device 350 also needs local key material (not shown), in particular one or more univariate private key polynomial(s) corresponding to identity number 355, together with a corresponding correction function.

First network device 300 comprises an electronic storage 320, a communication unit 342, a computation unit 330 and a key derivation device 340.

Storage 320 stores local key material of device 300. The device may be configured to work with a single instance of local key material, i.e., one univariate polynomial univariate private key polynomial and one public global reduction integer. In the embodiment shown in FIG. 2, the device 300 comprises a key material set 370. The device 300 may comprise multiple key material sets. The number of sets of key material may be 2 or larger than 2. The key material of device 300 may have been obtained from a system for configuring a network device for key sharing, such as system 200. Key material comprises a univariate private key polynomial, a public global reduction integer, and a correction function. For example, key material 370 comprises univariate private key polynomial 372, a public global reduction integer 374, and correction function 376. The public global reduction integer may be shared among some or all key material. However, the private key polynomials are preferably different in all sets.

Storage 320 also stores the identity number 310, A, that was used to generate the univariate private key polynomial in the key material. The key material may also comprise the identity number, especially in case a different identity number is used for each key material.

Storage 320 may be a memory, say a non-volatile and writable memory, such as flash memory. Storage 320 may be other types of storage, say magnetic storage such as a hard disk. Storage 320 may be write-once memory.

Communication unit 342 is configured to obtain the identity number 355 of second network device 350. Communication unit 342 may be implemented as a wired connection, say a Wi-Fi, Bluetooth or Zigbee connection. Communication unit 342 may be implemented with a connection over a data network, say the internet.

Computation unit 330 is configured to derive a key shared with device 350 corresponding to key material 370 in storage 320. Device 350 has key materials corresponding to key material 370. Below it is described how computation unit 330 may derive a single shared key using key material 370; however multiple instances may be combined.

Computation unit 330 may comprise a substituting unit 332, and an integer reduction unit 334. Substituting unit 332 and integer reduction unit 334 together form a polynomial manipulation unit 331. The latter is indicated with dashed lines.

Computation unit 330 is configured to substitute the identity integer A into the univariate private key polynomial 372 and reduce the result of the substitution modulo the public global reduction integer 374. Computation unit 330 may use similar hardware or software as substituting unit 222 and polynomial reduction unit 224. Note that first network device 300 does not have access to the first and second private set. The result of reduction unit 334 is an intermediate key.

Computation unit 330 further comprises a correction function evaluation unit 392 and a key modification unit 394; The latter two form a key-correction unit 391, indicated with dashed lines.

The correction function evaluation unit 392 is arranged to substitute the second identity number into the private correction function obtaining a correction factor. Evaluating the correction function uses an evaluation method appropriate to the type of storage of the function. For example, if correction function 376 is stored as sequence of breakpoints, the function is evaluated by finding two breakpoints in between which identity number 355 falls. For example, if correction function 376 is stored as an approximating rational polynomial, then the rational polynomial is evaluated, say as rational numbers, and rounded.

The result is a correction factor which may be used to modify the intermediate key.

Key modification unit 394 is arranged to receive the intermediate key, and the correction factor to modify the intermediate key with the correction factor to obtain a corrected key. For example, the key modification unit 394 may multiply the correction factor with the public global modulus 374 and add the result to the intermediate key. The latter is then reduced modulo 2^{b}.

Optionally computation unit 330 comprises a key-reconciliation unit 336. It may happen that device 300 and device 350 do not arrive at the same shared key. An application may chose to ignore this possibility. In doing so, some pairs of network devices may not be able to engage in encrypted and/or authenticated communication as they lack a common shared key. For some applications it is sufficient that only some pairs of network devices are secured, e.g., ad-hoc networks are an example of this. Devices 300 and 350 may also be configured with an optional key-reconciliation unit 336. In one of the two devices 300 and 350 the key-reconciliation unit 336 generates key-reconciliation data from the generated key and sends it to the other device; in the other device key-reconciliation unit 336 uses received key-reconciliation data to adapt the generated key so that the shared key derived in both devices is the same.

If key-reconciliation unit 336 is used to adapt keys, it adapts the generated key until it conforms to the key-reconciliation data, i.e., deriving key-reconciliation data from the adapted key would give the same result as the received key-reconciliation data for that key. Adapting keys may be done by adding a multiple of the public global reduction integer and reducing modulo 2^{b}, i.e., K_{BA}+δN mod 2^{b}.

For example, the key-reconciliation unit 336 in device 300 obtains a pre-determined number of least significant bits of the generated small key as key-reconciliation data. For example, the pre-determined number c may be chosen as the smallest number such that 2^{c}≧1+2D, wherein α is the degree of the polynomials in the first private set and m the number of polynomials. D denotes the remaining number of keys in the second set, i.e., the remaining uncertainty in the modified intermediate key. Preferably, D=3, as this corresponds to a value of 6, which is either 1, −1 or 0. As reconciliation data, device 350 may send the least 3 bits of the modified intermediate key. If the least significant bits are used as reconciliation data, the key-reconciliation unit adds multiples until the c least significant bits are the same as the received bits. Even if b=8, then κ bits remain for each instance. These 5 bits are do not require additional reconciliation however, a key of any desired length may be obtained by combining multiple instances, say 16 instances to obtain an 80 bit shared key.

Key derivation device 340 is configured to derive the shared key from the one or more keys that were derived, e.g., the modified intermediate key(s). The shared key is a so-called symmetric key. The result of the reduction is an integer. This result may be used almost directly as a key, say by concatenating its coefficients optionally after reconciliation.

Deriving the shared key from the result of the reduction may include the application of a key derivation function, for example the function KDF, defined in the OMA DRM Specification of the Open Mobile Alliance (OMA-TS-DRM-DRM-V2_0_2-20080723-A, section 7.1.2 KDF) and similar functions.

Instead of sending and receiving key-reconciliation data per b-bit key, the key-reconciliation unit may also be configured to generate key-reconciliation data over the assembled large shared key, possibly even after a key-reconciliation algorithm like KDF. In this case, the key-reconciliation unit adapts all small keys simultaneously until a large key is found that satisfies the key-reconciliation data. Although varying multiple small keys at the same is much more work, generating key-reconciliation data over the large key is also much more secure as less direct information is available for the small keys.

FIG. 2 further shows an optional cryptographic unit 345 in first network device 300. Cryptographic unit 345 is configured to use the shared key. For example, cryptographic unit 345 may be an encryption unit configured for encrypting an electronic message with the shared symmetric key. For example, cryptographic unit 345 may be a decryption unit configured for decryption an electronic message with the shared symmetric key.

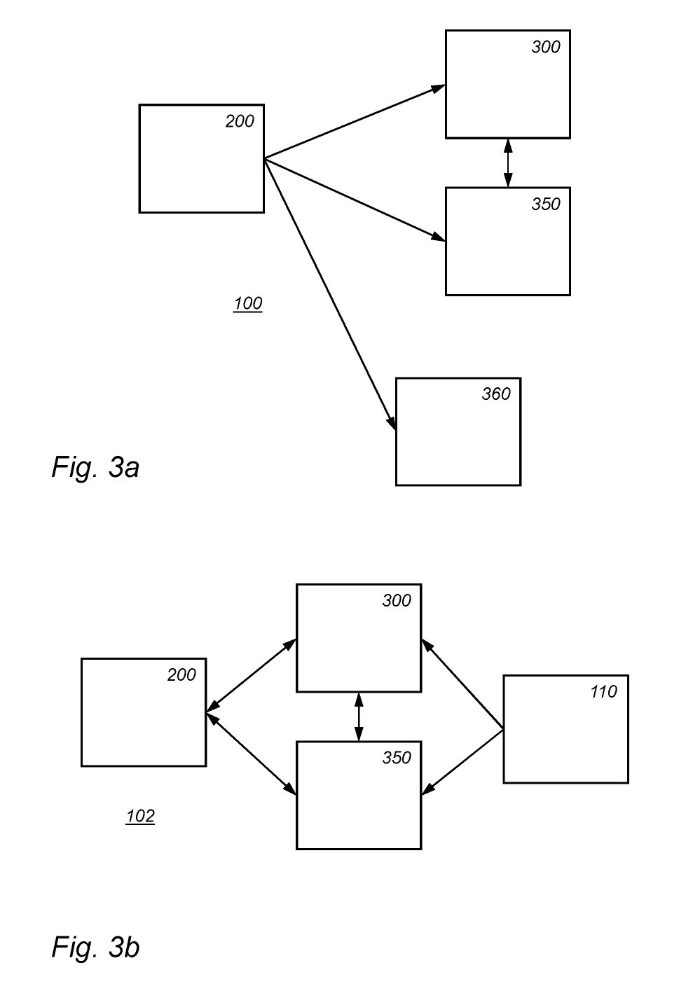

FIG. 3a is a schematic block diagram of a key sharing system 100.

Key sharing system 100 comprises system for configuring 200, and multiple network devices; shown are network device 300, 350 and 360. The network devices each receive an identity number, univariate private key polynomial, the global reduction integer, and a correction function from system for configuring 200. Using this information they can agree on a shared key. For example, first network device 300 and second network device 350 each send their identity numbers to the other party. They can then compute a shared key, e.g., by both first deriving an intermediate key, both deriving a corrected, modified intermediate key. Finally, one of the two may send reconciliation data, whereas the other adapts his modified intermediate key to match the received reconciliation data.

Someone with knowledge of the communication between first network device 300 and second network device 350 and even the global reduction integers cannot obtain their shared key, without using unreasonable large resources. Not even device 360 can derive the key shared between devices 300 and 350.

FIG. 3b is a schematic block diagram of a similar key sharing system 102. System 102 is the same as system 100 except that the network devices receive their identity numbers from a configuration server 110, also referred to as a personalization device. The network devices then register with system for configuring 200 by sending their identity number. Not even device 360 can obtain the key shared between devices 300 and 350.

The configuration server 110 may assign an identity number that is also used for other purposes. For example, configuration server 110 may assign a network address, such as a MAC address. The network address is used by the network node for routing network traffic from a second network node to itself. However, the network address may also double as the identity number. In this case, the network node makes its network address available to system 200 and receives a univariate private key polynomial which allows the network node to engage in encrypted communication using its network address as identity number. It is preferred that identity numbers have full entropy, i.e., B bits of entropy. However, when this cannot be realized, it is preferred to perform an entropy smoothing function, e.g., a hash function before using the number as the identity number.

The configuration server 110 may generate identity numbers to increase security of the system by avoiding identity numbers that are close, i.e., that share many or all of the most significant bits. For example, server 110 may generate the identity numbers randomly, say true or pseudo random. It is also sufficient to append predetermined number of random bits to an identity number, say 10 bits. The identity number may have the form A₁∥A₂, in which A₁ is not random, say a serial number, network address, or the like, and wherein A₂ is random. A₂ may be generated by a random number generator. A₂ may also be generated by hasing A₁. If a keyed hash is used, say an HMAC, this then A₂ is indistinguishable from random to parties without access to said key. The key may be generated and stored by server 110.

Server 110 may be included in system 200, e.g., incorporated in network manager 230.

Typically, the device 200 and the 300 each comprise a microprocessor (not shown) which executes appropriate software stored at the device 200 and 300; for example, that software may have been downloaded and/or stored in a corresponding memory, e.g., a volatile memory such as RAM or a non-volatile memory such as Flash (not shown). The devices 350 and 360 may also be equipped with microprocessors and memories (not shown). Alternatively, the devices 200 and 300 may, in whole or in part, be implemented in programmable logic, e.g., as field-programmable gate array (FPGA). Devices 200 and 300 may be implemented, in whole or in part, as a so-called application-specific integrated circuit (ASIC), i.e. an integrated circuit (IC) customized for their particular use.

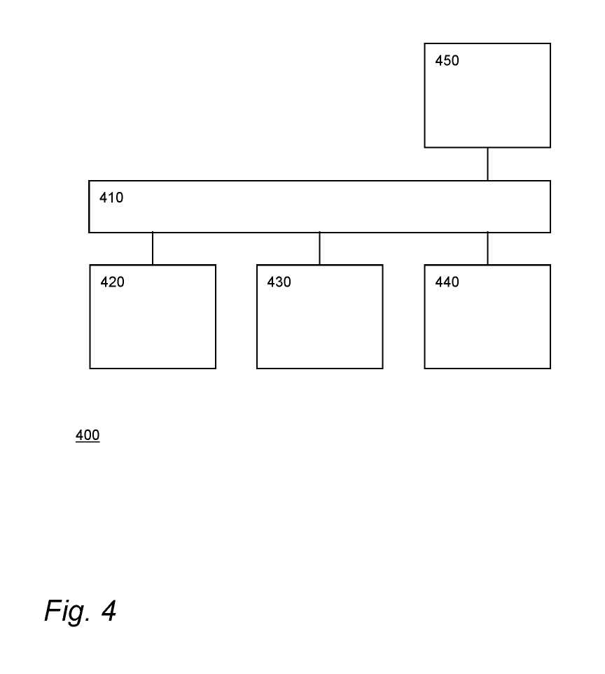

FIG. 4 is schematic block diagram of an integrated circuit 400. Integrated circuit 400 comprises a processor 420, a memory 430, and an I/O unit 440. These units of integrated circuit 400 can communicate amongst each other through an interconnect 410, such as a bus. Processor 420 is configured to execute software stored in memory 430 to execute a method as described herein, e.g. a method to configure a device, or a method to determine a shared key. In this way integrated circuit 400 may be configured as system for configuring 200 or as a network device, such as first network device 300; Part of memory 430 may store public global reduction integers, first private sets of bivariate polynomials, second private sets of reduction integers, identity numbers, a plain message and/or encrypted message as required.

I/O unit 440 may be used to communicate with other devices such as devices 200, or 300, for example to receive key data, such as first private set of bivariate polynomials 252 and possibly associated parameters, such as sizes, degrees, moduli and the like, or to send and receive encrypted and/or authenticated messages. I/O unit 440 may comprise an antenna for wireless communication. I/O unit 440 may comprise an electric interface for wired communication.

Integrated circuit 400 may be integrated in a computer, mobile communication device, such as a mobile phone, etc. Integrated circuit 400 may also be integrated in lighting device, e.g., arranged with an LED device. For example, an integrated circuit 400 configured as a network device and arranged with lighting unit such as an LED, may receive commands encrypted with a shared symmetric key.

Multiple network devices, say incorporated in a lighting device, may form the nodes of an encrypted network, in which links are encrypted using shared keys between the nodes.

Integrated circuit 400 may be integrated in other devices that desire fast symmetric key agreement. Integrated circuit 400 may be integrated in a payment system. Integrated circuit 400 may be integrated in a car. A plurality of such cars may be arranged for car-to-car communication, in which car-to-car messages are encrypted and/or authenticated using the shared key.

Although polynomial manipulation may be performed by processor 420 as instructed by polynomial manipulation software stored in memory 430, the tasks of key generation, and calculating the univariate polynomials are faster if integrated circuit 400 is configured with optional polynomial manipulation unit 450. In this embodiment, polynomial manipulation unit 450 is a hardware unit for executing substitution and reduction operations.

Typically, the devices 200, and 300 each comprise a microprocessor (not shown) which executes appropriate software stored at the device 200 and the 300; for example, that software may have been downloaded and/or stored in a corresponding memory, e.g., a volatile memory such as RAM or a non-volatile memory such as Flash (not shown). Alternatively, the devices 200 and 300 may, wholly or partially, be implemented in programmable logic, e.g., as field-programmable gate array (FPGA).

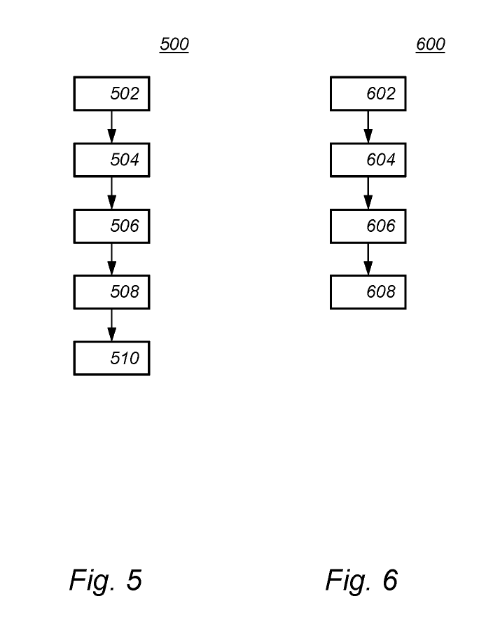

FIG. 5 schematically illustrates as a flowchart a method 500 to determine a shared key with a second device. The method comprises Storing 502
a first identity number (A),
a private correction function (Λ_{A}( )),
a first private univariate key polynomial (372, G_{A}( )).

Obtaining 504 a second identity number (355,B) of the second device.

Substituting 506 the second identity number into the private univariate key polynomial, obtaining an intermediate key, the intermediate key defining a first key set.

Substituting 508 the second identity number into the private correction function obtaining a correction factor.

Modifying 510 the intermediate key with the correction factor to obtain a corrected key, the corrected key defining a second key set, the second set being smaller than the first set.

A shared key may be derived from at least the corrected key.

FIG. 6 schematically illustrates as a flowchart a method 600 a device 300 for sharing a key. The method comprises

Obtaining 602 in electronic form root key material.

Obtaining 604 in electronic form a first identity number (310, A) for the device.

Computing 606 for the device a private univariate key polynomial (229) and a private correction function (Λ_{A}( )) from the root key material and the first identity number (310, A)

Storing 608 the generated private univariate key polynomial (229, 236) and the private correction function (Λ_{A}( )) at the device.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method.

A method according to an embodiment may be executed using software, which comprises instructions for causing a processor system to perform method 500 or 600. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server. A method may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to an embodiment. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It should be noted that the above-mentioned embodiments illustrate rather than limit the invention, and that those skilled in the art will be able to design many alternative embodiments.

Advantageous embodiments for biometric verification are set out in the following clauses. The Applicants hereby give notice that new claims may be formulated to such clauses and/or combinations of such clauses and/or features taken from the description, during prosecution of the present application or of any further application derived therefrom.

1. A first device (300) configured to determine a shared key with a second device (350), the first device comprising
an electronic storage (320) for storing
   a first identity number (310, A),
   a first private correction function (376, Λ_{A}( )),
   a first private univariate key polynomial (372, G_{A} ( )),
      the second device (350) having access to a second private univariate key polynomial (G_{B} ( )) and a second correction function (Λ_{B} ( )), being arranged to obtain a second intermediate key from substituting the first identity number (310, A) into the second private univariate key polynomial (G_{B} ( )), and being arranged to obtain a second corrected key from modifying the second intermediate key with a correction factor,
a communication unit (342) arranged to obtain a second identity number (355, B) of the second device,
a polynomial manipulation unit (331) arranged to
   substitute the second identity number (355) into the first private univariate key polynomial (372), obtaining a first intermediate key, the first intermediate key defining a first key set, the second intermediate key derived by the second device being comprised in the first key set,
a key-correction unit (391) arranged to
   substitute the second identity number (355) into the first private correction function (376) obtaining a first correction factor, and
   modifying the first intermediate key with the first correction factor to obtain a first corrected key, the first corrected key defining a second key set, the second key set being smaller than the first key set, the second key set comprising the second corrected key, the first device being arranged to derive the shared key from at least the first corrected key.
      2. A first device (300) as in Clause 1, wherein the first private correction function (376) is monotonic and/or non-polynomial.
      3. A first device (300) as in any one of the preceding clauses, wherein the first private correction function (Λ_{A})) is a rounded polynomial with rational coefficients.
      4. A first device (300) as in Clause 3, wherein the first private correction function (Λ_{A}( )) is a rounded polynomial with a single term having a rational coefficient (Λ_{A}(y)=[Ry^{α}]).
      5. A first device (300) as in Clause 2, wherein the first private correction function (376, Λ_{A}( )), is stored as an increasing sequence of integer breakpoints I_{A,1}, I_{A,2}, . . . such that Λ_{A}(x)=0 if x≦I_{A,1}, and such that Λ_{A}(x)=i if I_{A,i}<X<I_{A,i+1}.
      6. A first device (300) as in any one of the preceding clauses, wherein the first private univariate key polynomial (372, G_{A}( )), has been obtained by a system (200) for configuring a device (300) by obtaining a set of univariate polynomials by, for each particular polynomial of a first private set of bivariate polynomials (252, fᵢ(,)) substituting the first identity number (A) into said particular polynomial (fᵢ(A,)) and reducing modulo a reduction integer (pᵢ) associated with said particular polynomial, and summing the set of univariate polynomials.
      7. A first device (300) as in Clause 6, wherein the private reduction integers pᵢ satisfy pᵢ=N−βᵢ2^{b}, for some integers βᵢ with βᵢ<2^{B}, and a public global reduction integer (256, N).
      8. A first device (300) as in any one of the preceding clauses, wherein the first key set is defined by the first intermediate key by adding or subtracting a multiple of a correction term, the multiple being less than an upper bound and more than a lower bound.
      9. A first device (300) as in any one of the preceding clauses, wherein the electronic storage (320) further stores a public global reduction integer (374, N), and modifying the first intermediate key comprises multiplying the first correction factor with the public global reduction integer (374, N) and adding or subtracting the result of the multiplication to the first intermediate key.
      10. A first device (300) as in Clause 9, wherein the polynomial manipulation unit is further arranged to reduce the result of the substituting modulo the public global reduction integer (N), and further reducing the result of the reducing modulo the public global reduction integer (N) modulo 2^{b} to obtain the first intermediate key, wherein the first intermediate key is b bits long, modifying the first intermediate key further comprises reducing modulo 2^{b} after the adding or subtracting.
      11. A first device (300) as in any one of the preceding clauses, wherein
the communication unit (342) is further arranged to receive key-reconciliation data from the second device, the first device comprising a key-reconciliation unit (336) arranged to modify the first corrected key to conform to the received key-reconciliation data, the shared key being derived from the modified first corrected key.
   12. A system (200) for configuring a first device (300) for sharing a key, the system comprising:
a key material obtainer (210) arranged to obtain in electronic form root key material,
a device manager (230) for obtaining in electronic form at least a first identity number (310, A) for the first device
a computation unit (220) for computing for the device a private univariate key polynomial (229, G_{A}( )) and a private correction function (271, Λ_{A}( )) from the root key material and the first identity number (310, A) for use in a first device as in Clause 1,
the device manager (230) being further configured for electronically storing the generated private univariate key polynomial (229, 236) and the private correction function (271, Λ_{A}( )) at the first device.
   13. A system (200) for configuring a device (300) as in Clause 12, wherein
the root key material comprises a first private set of bivariate polynomials (252, fᵢ(,)), and a second private set of reduction integers (254, pᵢ), with each bivariate polynomial in the first set there is associated a reduction integer of the second set, the key material obtainer (210) is further arranged to obtain a public global reduction integer (256, N),
the computation unit (220) is arranged to compute for the device the private univariate key polynomial (229, G_{A}( )) from the first and second private sets by
   obtaining a set of univariate polynomials by
      for each particular polynomial of the first private set, substituting the first identity number (A) into said particular polynomial (fᵢ(A,)) and reducing modulo the reduction integer associated with said particular polynomial, and
   summing the set of univariate polynomials,
      14. A system (200) for configuring a device (300) as in Clause 10, wherein the computation unit is arranged to compute the correction function Λ_{A}(X) by approximating the function

$${Λ}_{A}^{′} ( X ) = {\sum }_{i = 1}^{m} \frac{N - {p}_{i}}{N {p}_{i}} {A}_{A}^{( i )} ( X )$$

wherein A_{A}⁽ⁱ⁾(X)= [symbol] fᵢ(A,X) [symbol] ₚ_{ᵢ}, wherein fᵢ(,) represent the first private set of bivariate polynomials (252) and pᵢ represent the second private set of reduction moduli.
15. A method to determine a shared key with a second device (350), the method comprising
storing
   a first identity number (A),
   a first private correction function (Λ_{A}( )),
   a first private univariate key polynomial (372, G_{A}( )),
obtaining a second identity number (355,B) of the second device,
substituting the second identity number into the private univariate key polynomial, obtaining a first intermediate key, the intermediate key defining a first key set,
substituting the second identity number into the first private correction function obtaining a first correction factor,
modifying the first intermediate key with the first correction factor to obtain a first corrected key, the first corrected key defining a second key set, the second set being smaller than the first key set.
   16. A method for configuring a device (300) for sharing a key, the method comprising:
obtaining in electronic form root key material,
obtaining in electronic form a first identity number (310, A) for the device,
computing for the device a private univariate key polynomial (229) and a first private correction function (Λ_{A}( )) from the root key material and the first identity number (310, A)
electronically storing the generated private univariate key polynomial (229, 236) and the first private correction function (Λ_{A}( )) at the device.
   17. A computer program comprising computer program code means adapted to perform all the steps of clause 15 or 16 when the computer program is run on a computer.
   18. A computer program as in clause 17 embodied on a computer readable medium.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

### LIST OF REFERENCE NUMERALS IN FIGS. 1-4

100,102 a key sharing system
110 a personalization device
200 a system for configuring a network device for key sharing
210 a key material obtainer
220 a computation unit
222 a substituting unit
224 a polynomial reduction unit
226 a polynomial addition unit
228 sum of a set of univariate polynomials
229 univariate private key polynomial
230 a network device manager
232 an identity number message
236 a private key material message
238 a connection
240 a polynomial manipulation unit
250 a parameter set
252 a first private set of bivariate polynomials
254 a second private set of reduction integers
256 a public global reduction integer
270 a correction function unit
271 a correction function
300 a first network device
310 an identity number
320 an electronic storage
330 a computation unit
331 a polynomial manipulation unit
332 a substituting unit
334 an integer reduction unit
336 a key reconciliation unit
340 a key derivation device
342 a communication unit
345 a cryptographic unit
350 a second network device
355 an identity number
360 a third network device
370 a key material set
372 a private univariate key polynomial
374 a public global reduction integer
376 a correction function
391 a key-correction unit
392 a correction function evaluation unit
394 a key modification unit
400 an integrated circuit
410 an interconnect
420 a processor
430 a memory
440 an I/O unit
450 a polynomial manipulation unit

1. A first device configured to determine a shared key with a second device, the first device comprising
an electronic storage for storing
a first identity number,
a first private correction function,
a first private univariate key polynomial,
the second device having access to a second private univariate key polynomial (G_{B}( )) and a second correction function (Λ_{B}( )), being arranged to obtain a second intermediate key from substituting the first identity number into the second private univariate key polynomial (G_{B}( )), and being arranged to obtain a second corrected key from modifying the second intermediate key with a correction factor, the first and second private correction function being non-polynomial, integer-valued, monotonic functions,
a communication unit arranged to obtain a second identity number of the second device,
a polynomial manipulation unit arranged to
substitute the second identity number into the first private univariate key polynomial, obtaining a first intermediate key, the first intermediate key defining a first key set, the second intermediate key derived by the second device being comprised in the first key set,
a key-correction unit arranged to
substitute the second identity number into the first private correction function obtaining a first correction factor, and
modifying the first intermediate key with the first correction factor to obtain a first corrected key, the first corrected key defining a second key set, the second key set being smaller than the first key set, the second key set comprising the second corrected key, the first device being arranged to derive the shared key from at least the first corrected key.

2. (canceled)

3. A first device as in claim 1, wherein the first private correction function (Λ_{A}( )) is a rounded polynomial with rational coefficients.

4. A first device as in claim 3, wherein the first private correction function (Λ_{A}( )) is a rounded polynomial with a single term having a rational coefficient (Λ_{A}(y)=|Ry^{α}|).

5. A first device as in claim 1, wherein the first private correction function (376, Λ_{A}( )), is stored as an increasing sequence of integer breakpoints I_{A,1}, I_{A,2}, . . . such that Λ_{A}(x)=0 if x≦I_{A,1}, and such that Λ_{A}(x)=i if I_{A,i}<x≦I_{A,i+1}.

6. A first device as in claim 1, wherein the first private univariate key polynomial (G_{A}( )), has been obtained by a system for configuring a device by obtaining a set of univariate polynomials by, for each particular polynomial of a first private set of bivariate polynomials (fᵢ(,)) substituting the first identity number (A) into said particular polynomial (fᵢ(A,)) and reducing modulo a reduction integer (pᵢ) associated with said particular polynomial, and summing the set of univariate polynomials.

7. A first device as in claim 6, wherein the private reduction integers A, satisfy pᵢ=N−βᵢ2^{b}, for some integers βᵢ with βᵢ<2^{B}, and a public global reduction integer (N).

8. A first device as in claim 1, wherein the first key set is defined by the first intermediate key by adding or subtracting a multiple of a correction term, the multiple being less than an upper bound and more than a lower bound.

9. A first device as in claim 1, wherein the electronic storage further stores a public global reduction integer (N), and modifying the first intermediate key comprises multiplying the first correction factor with the public global reduction integer (N) and adding or subtracting the result of the multiplication to the first intermediate key.

10. A first device as in claim 9, wherein the polynomial manipulation unit is further arranged to reduce the result of the substituting modulo the public global reduction integer (N), and further reducing the result of the reducing modulo the public global reduction integer (N) modulo 2^{b} to obtain the first intermediate key, wherein the first intermediate key is b bits long, modifying the first intermediate key further comprises reducing modulo 2^{b} after the adding or subtracting.

11. A first device as in claim 6, wherein the correction function Λ_{A}(X) approximates the function
$${Λ}_{A}^{′} ( X ) = {\sum }_{i = 1}^{m} \frac{N - {p}_{i}}{N {p}_{i}} {A}_{A}^{( i )} ( X )$$
wherein A_{A}⁽ⁱ⁾(X)= [symbol] fᵢ(A,X) [symbol] ₚ_{ᵢ}, wherein fᵢ(,) represent the first private set of bivariate polynomials (252) and pᵢ represent the second private set of reduction moduli.

12. A first device as in claim 1, wherein
the communication unit is further arranged to receive key-reconciliation data from the second device, the first device comprising a key-reconciliation unit arranged to modify the first corrected key to conform to the received key-reconciliation data, the shared key being derived from the modified first corrected key.

13. system for configuring a first device for sharing a key, the system comprising:
a key material obtainer arranged to obtain in electronic form root key material,
a device manager for obtaining in electronic form at least a first identity number (A) for the first device
a computation unit for computing for the device a private univariate key polynomial (G_{A}( )) and a private correction function (Λ_{A}( )) from the root key material and the first identity number (A) for use in a first device as in claim 1, the first private correction function being a non-polynomial integer-valued, monotonic function,
the device manager being further configured for electronically storing the generated private univariate key polynomial and the private correction function (Λ_{A}( )) at the first device.

14. A system for configuring a device as in claim 13, wherein
the root key material comprises a first private set of bivariate polynomials (fᵢ(,), and a second private set of reduction integers (pᵢ), with each bivariate polynomial in the first set there is associated a reduction integer of the second set, the key material obtainer is further arranged to obtain a public global reduction integer (N),
the computation unit is arranged to compute for the device the private univariate key polynomial (G_{A}( )) from the first and second private sets by
obtaining a set of univariate polynomials by
for each particular polynomial of the first private set, substituting the first identity number (A) into said particular polynomial (fᵢ(A,)) and reducing modulo the reduction integer associated with said particular polynomial, and
summing the set of univariate polynomials,

15. A system for configuring a device as in claim 14, wherein the computation unit is arranged to compute the correction function Λ_{A}(X) by approximating the function
$${Λ}_{A}^{′} ( X ) = {\sum }_{i = 1}^{m} \frac{N - {p}_{i}}{N {p}_{i}} {A}_{A}^{( i )} ( X )$$
wherein A_{A}(i)(X)= [symbol] fᵢ(A,X) [symbol] ₚ_{ᵢ}, wherein fᵢ(,) represent the first private set of bivariate polynomials and pᵢ represent the second private set of reduction moduli.

16. A method to determine a shared key with a second device, the method comprising
storing
a first identity number (A),
a first private correction function (Λ_{A}( )), the first private correction function being a non-polynomial integer-valued, monotonic function,
a first private univariate key polynomial (G_{A}( )),
obtaining a second identity number (B) of the second device,
substituting the second identity number into the private univariate key polynomial, obtaining a first intermediate key, the intermediate key defining a first key set,
substituting the second identity number into the first private correction function obtaining a first correction factor,
modifying the first intermediate key with the first correction factor to obtain a first corrected key, the first corrected key defining a second key set, the second set being smaller than the first key set.

17. A method for configuring a device for sharing a key, the method comprising:
obtaining in electronic form root key material,
obtaining in electronic form a first identity number (A) for the device,
computing for the device a private univariate key polynomial and a first private correction function (Λ_{A}( )) from the root key material and the first identity number (A) the first private correction function being a non-polynomial integer-valued, monotonic function,
electronically storing the generated private univariate key polynomial and the first private correction function (Λ_{A}( )) at the device.

18. A computer program comprising instructions which, when executed on a computer, would cause a processor to perform the method of claim 16.

19. A computer readable medium storing a computer program as in claim 18.
